(19) United States
(12) Patent Application Publication
(10) Pub. No.: US 2003/0229850 A1
(43) Pub. Date: Dec. 11, 2003

(54) Web browser

(76) Inventor: Calvin Lue, San Jose, CA (US)

Correspondence Address: David B. Ritchie, THELEN REID & PRIEST LLP, P.O. Box 640640, San Jose, CA, 95164-0640, US

(21) Appl. No.: 10/165,619

(22) Filed: Jun. 7, 2002

(51) Int. Cl. G06F 17/00

(52) U.S. Cl. 715/513

(57) ABSTRACT

An improved web browser is provided wherein a user may create and save presentation rules regarding the display of a web page to better utilize available space on the display. This is especially helpful in limited display devices. The user may select a portion of the web page to be added or subtracted. The web page may be translated into a tree structure and the sub-tree representing the portion may be identified using an anchor. The identifying of the anchor may be accomplished by ignoring layout-decorator nodes in the tree structure. The anchor may be saved as a presentation rule. When the page is next displayed, the presentation rule may be retrieved and applied to the web page before it is displayed.

### FIELD OF THE INVENTION

The present invention relates to the field of software World Wide Web browsers. More particularly, the present invention relates to an improved browser.

### BACKGROUND OF THE INVENTION

Web Browsers are currently utilized by millions of computer users to access World Wide Web pages on the Internet. Many of these websites are designed to be viewed on a 1024×768 display, which is currently the most popular resolution of computer displays. However, computers with smaller resolution displays encounter problems in viewing these web sites. These limited display devices (LDDs) cannot display the entire web page on the screen at once. While users generally accept scrolling web pages up or down in order to view the portion of the page they desire, they are normally unwilling to accept the scrolling of web pages from side to side. Thus, the market size and value of limited display devices (which include personal digital assistants, cell phones, computers in cars, set-top boxes, TVs, and to a lesser extent, smaller or older laptop computers) are reduced by this limited display problem. As the resolution of computer displays continues to grow, this problem will become even more pronounced.

Attempts to solve this problem in the past can be grouped in two categories: reauthorization and translation. In reauthorization, the websites themselves are redesigned and reformatted so that they can be properly viewed by a limited display device. The contents of the sites are generally trimmed down and simplified, so that they require less space for display. The trimmed down version may then be converted to a special format accepted by the target devices (if necessary). For example, a website provider may create a special PDA version of their site at a different address than the normal, computer version. The problem with this approach is it requires the website provider to generate unique web pages for the LDDs, which creates more overhead. Additionally, the special LDD addresses may not be widely known to the public, thus the dissemination of the addresses becomes of greater importance. This can be difficult as the user will have limited visibility of the “normal” web site on the LDD, and thus may be unable to discover the special LDD address or even know one is available.

The other category of approaches to this problem is translation. Unlike the reauthorization approach which alters contents at their source, the translation approach attempts to insert a layer between content sources and end users, using a translation layer to tailor contents for a specific device. The first phase of this is a preparation phase to analyze existing websites or web applications and decide what contents will be included or discarded in the final delivery to end users. The second phase is to summarize the translation into several rules and develop an application to exercise those rules. In this second phase, third party software tools and/or application servers are commonly used to prevent constructing the whole project from the ground up, which can be very tedious and cost as much as completely redesigning the whole website. Due to the overhead of this approach, however, it cannot be executed in real-time. Thus, the system must have some foreknowledge of destinations visited by users.

### BRIEF DESCRIPTION OF THE INVENTION

An improved web browser is provided wherein a user may create and save presentation rules regarding the display of a web page to better utilize available space on the display. This is especially helpful in limited display devices. The user may select a portion of the web page to be added or subtracted. The web page may be translated into a tree structure and the sub-tree representing the portion may be identified using an anchor. The identifying of the anchor may be accomplished by ignoring layout-decorator nodes in the tree structure. The anchor may be saved as a presentation rule. When the page is next displayed, the presentation rule may be retrieved and applied to the web page before it is displayed.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a flow diagram illustrating the initial operation of a method for viewing a web page in accordance with a specific embodiment of the present invention.

FIG. 2 is a flow diagram illustrating a method for selecting a portion of a web page in accordance with a specific embodiment of the present invention.

FIG. 3 is a flow diagram illustrating a method for subtracting a portion of a web page in accordance with a specific embodiment of the present invention.

FIG. 4 is a diagram illustrating a sample tree in accordance with a specific embodiment of the present invention.

FIG. 5 is a diagram illustrating a modified sample tree in accordance with a specific embodiment of the present invention.

FIG. 6 is a diagram illustrating a tree structure for this example before applying the layout invariant property in accordance with a specific embodiment of the present invention.

FIG. 7 is a diagram illustrating a modification of the tree structure of FIG. 6 after the layout invariant property has been applied in accordance with a specific embodiment of the present invention.

FIG. 8 is a diagram illustrating a tree structure for this modified example before applying the layout invariant property in accordance with a specific embodiment of the present invention.

FIG. 9 is a diagram illustrating a modification of the tree structure of FIG. 8 after the layout invariant property has been applied in accordance with a specific embodiment of the present invention.

FIG. 10 is a flow diagram illustrating a method for selecting a portion of a web page in accordance with a specific embodiment of the present invention.

FIG. 11 is a flow diagram illustrating a method for subtracting a portion of a web page from a selected portion of the web page in accordance with a specific embodiment of the present invention.

FIG. 12 is a flow diagram illustrating a method for displaying a web page in accordance with one or more presentation rules saved for the web page in accordance with a specific embodiment of the present invention.

FIG. 13 is a block diagram illustrating an apparatus for selecting a portion of a web page in accordance with a specific embodiment of the present invention.

FIG. 14 is a block diagram illustrating an apparatus for subtracting a portion of a web page from a selected portion of the web page in accordance with a specific embodiment of the present invention.

FIG. 15 is a block diagram illustrating an apparatus for displaying a web page in accordance with one or more presentation rules saved for the web page in accordance with a specific embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention utilizes an improved web browser specifically designed for limited display devices (LDDs) to allow users to properly view web pages on such devices without eliciting help from servers or additional devices. End users are able to slice-and-dice web pages in real time to display a portion of the contents of the web site best suited for the user's interests. They may also zoom in on selected portions of the web page so that they may be better displayed on a limited display device.

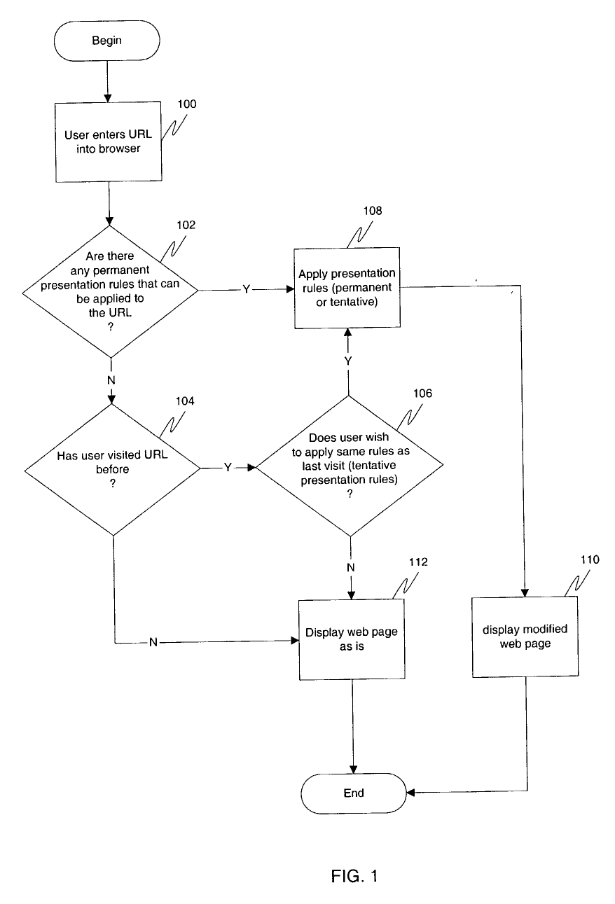

FIG. 1 is a flow diagram illustrating the initial operation of a method for viewing a web page in accordance with a specific embodiment of the present invention. At 100, the user enters a uniform resource locator (URL) address. At 102, the browser checks to see if there are any permanent presentation rules that can be applied to the URL. This may include looking up a user profile for the user and determining whether any saved rules are listed for the URL. If there are no permanent presentation rules for the URL, at 104 the browser determines if the user has ever visited the URL before. A history of previously viewed web pages may be saved in the user profile or via some other mechanism. If the user has visited the URL before, they may have slice and diced the page but not saved these changes as permanent rules. Thus, at 106, the browser determines if there are any tentative presentation rules saved for the URL and whether the user wishes to apply those rules. If so, or if at 102 it was determined there were permanent presentation rules for the URL, then at 108 the presentation rules (permanent or tentative) are applied to the web page. Then, at 110, the modified web page may be displayed. If there were no tentative presentation rules or the user did not wish to apply them, or if the user has never visited the URL before, the web page may be displayed as is at 112. Once the page has been displayed, users may slice and dice it by applying selection, subtraction, and aggregation as will be discussed below.

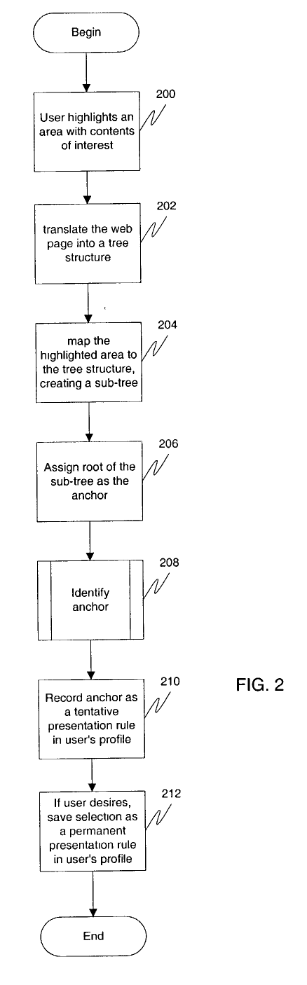

When a user wishes to modify a portion of a web page, he must first select the portion. FIG. 2 is a flow diagram illustrating a method for selecting a portion of a web page in accordance with a specific embodiment of the present invention. At 200, the user highlights an area with contents of interest. This may involve moving a mouse cursor to one corner of the portion to be selected, clicking the mouse button, then while holding the mouse button moving the mouse to the opposite corner. This is commonly known as “clicking and dragging”. By doing so, the user can enlarge or reduce the scope of selection. However, many limited display devices do not have a mouse, but rather have styluses, or keypads, for example. In such cases, the system may select an entire area when any point or portion of the area is selected. The area may then be expanded by the user clicking on a special button. Then at 202, the web page is translated into a tree structure. In one embodiment of the present invention, a document object model (DOM) tree structure is used. At 204, the selected portion is mapped to the tree structure as a sub-tree. At 206, the root of the sub-tree is used as an anchor. The anchor will later be used to retrieve or filter contents of interest.

At 208, the anchor is identified so that the selection can be applied the next time the user visits the same page. Special care needs to be taken to identify the anchor so that when a page is update with new contents, the appropriate selection can be recovered. Therefore, this identification of the anchor will be discussed in greater detail below. Once the anchor is identified, the browser may record the anchor as a tentative presentation rule at 210. At 212, upon the user's request, the browser may save the selection as a permanent presentation rule in the user's profile. In a specific embodiment of the present invention, the XML Path Language (XPath), which is a World Wide Web Consortium (W3C) standard, may be utilized to record anchors. However, one of ordinary skill in the art will recognize that there may be many different ways to record anchors.

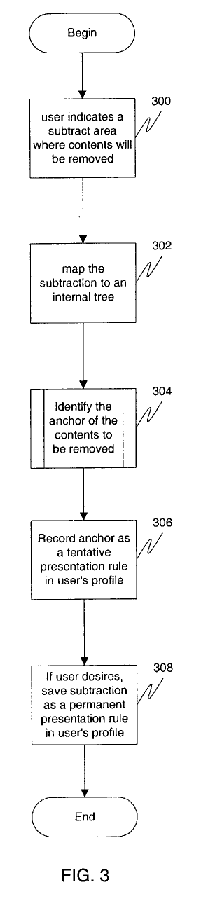

The user may also indicate an area to be subtracted. This is useful for identifying regions that the user knows he doesn't need to see. FIG. 3 is a flow diagram illustrating a method for subtracting a portion of a web page in accordance with a specific embodiment of the present invention. At 300, the user indicates a subtract area where contents may be removed. In a specific embodiment of the present invention, the subtract area may be highlighted with a different color from the selection area. At 302, the subtraction may be mapped to the internal tree. At 304, the anchor of the contents to be removed is identified. The identification of the anchor will be discussed in more detail below. At 306, the anchor may be recorded as a tentative presentation rule in the user's profile. At 308, if the user so desires, the subtraction may be saved as a permanent presentation rule in the user's profile.

The selections and subtractions may be applied in various combinations depending upon user preferences. For example, if the user highlights a certain portion as a selected area, then highlights a different portion as a subtraction area, the browser can display just the selected area, or the entire web page minus the subtracted area, or a combination of both, where the browser displays the selected area minus the subtracted area (if they overlap, for instance). When multiple selections or subtractions are combined by the browser to produce a new view, this process is known as aggregation. Upon the user's request, the aggregation may be saved as a permanent presentation rule in the user's profile.

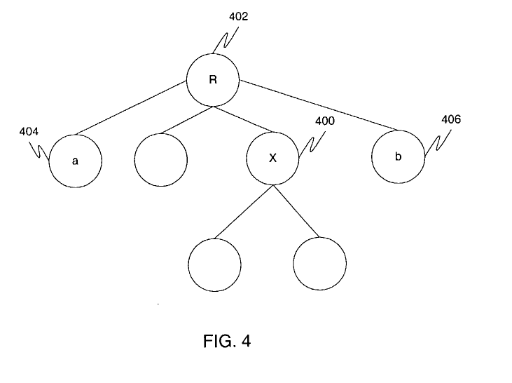

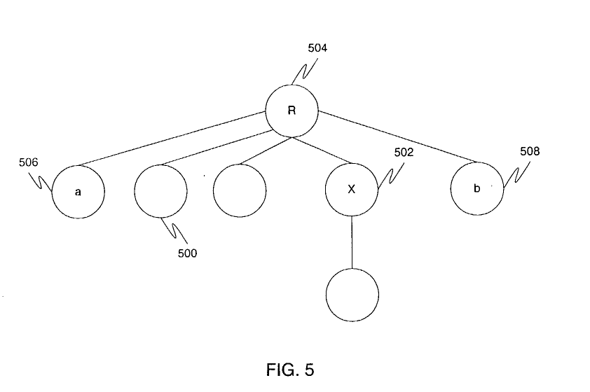

As discussed briefly above, identifying an anchor requires special care. FIG. 4 is a diagram illustrating a sample tree in accordance with a specific embodiment of the present invention. If X 400 is the anchor, there are many ways that anchor may be identified. For example, it can be described as the third child of R 402. It can also be described as the second node to the right of node a 404. It can also be described as the first node to the left of node b 406. It can also be described as the node with two child nodes. However, if some changes are made to the tree, many descriptions won't be able to identify the X node anymore. FIG. 5 is a diagram illustrating a modified sample tree in accordance with a specific embodiment of the present invention. Node 500 has been added. Thus, X 502 is no longer the third child of R 504. Nor is it the second node to the right of node a 506. Nor is it the node with two child nodes. Thus, only the description that it is the first node to the left of node b 508 is still correct, and that could easily be wrong if a node is added between X 502 and b 508.

Therefore, when describing a web page in a tree structure such as a DOM tree, identifying the anchor properly can be quite challenging. Because web pages are constantly updated with new contents, describing the anchor properly is very important. In a specific embodiment of the present invention, a layout invariant property is used to aid in the identification of the anchor. This property indicates that the layout of an HTML document (or XML document annotated by cascading style sheet (CSS)) is dominantly decided by certain tags only. In other words, not every tag has the same degree of impact on page layout. Therefore, if document tags are categorized as layout determinants and layout-decorators, the layout-decorators can be removed from a page and the result will exhibit a similar layout as the original page.

Layout-determinant tags are tags that change the layout flow. For examine, if terms defined in the CSS are used, layout-determinant tags are block-level tags. They depict the skeleton of a page layout.

Layout-decorator tags, on the other hand, are tags adding contents (text, images, or any other user-interface components such as applets) or tags adding styles (such as font, color, size, etc.) to content. Because they are intended to fill the space determined by layout-determinants, they have minimum impact to the page layout.

Consider, for example, an HTML file as follows:

<body>

<p>First <b>paragraph</b>.</p>

<p>Second paragraph.<p>

</body>

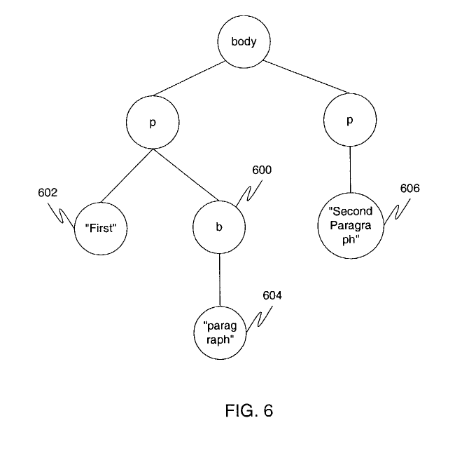

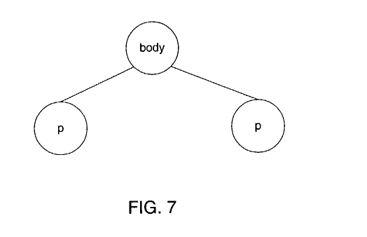

FIG. 6 is a diagram illustrating a tree structure for this example before applying the layout invariant property in accordance with a specific embodiment of the present invention. Applying the layout invariant property removes the layout-decorators out of the internal tree structure. In this example, layout-decorators include the <b> tag 600 and the text nodes 602, 604, 606. FIG. 7 is a diagram illustrating a modification of the tree structure of FIG. 6 after the layout invariant property has been applied in accordance with a specific embodiment of the present invention.

Now assume that the HTML file is modified to the following:

<body>

<p>First paragraph.</p>

<p>Second paragraph with <b>a lot more</b>contents in it/</p>

</body>

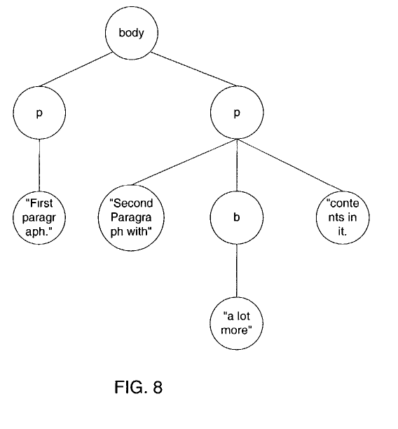

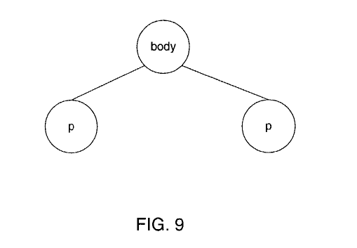

FIG. 8 is a diagram illustrating a tree structure for this modified example before applying the layout invariant property in accordance with a specific embodiment of the present invention. As can be seen, it is different from FIG. 6. However, FIG. 9 is a diagram illustrating a modification of the tree structure of FIG. 8 after the layout invariant property has been applied in accordance with a specific embodiment of the present invention. As can be seen, it is identical to FIG. 7.

By applying the layout invariant property, a document tree may be transformed to a layout-invariant tree by removing tags which are layout-decorators. The resulting tree is layout invariant, as it remains the same even when page content is changed. This result tree is much more useful in identifying an anchor than the original tree because the result tree won't be changed because of content updates, and thus the mistake of identifying the wrong anchor will be avoided. In practice, however, it is generally not required that the tree structure actually be transformed. The system may traverse a tree structure, ignoring layout-decorators as per the layout invariant property.

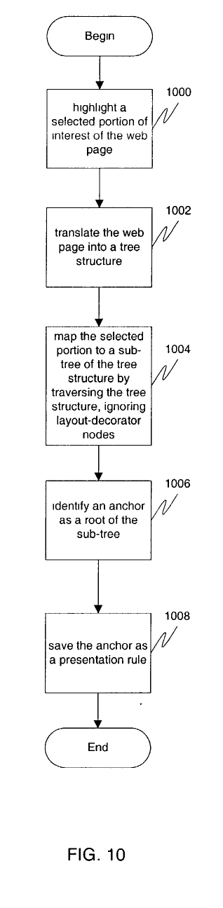

FIG. 10 is a flow diagram illustrating a method for selecting a portion of a web page in accordance with a specific embodiment of the present invention. At 1000, a selected portion of interest of the web page may be highlighted. This may include clicking and dragging. At 1002, the web page may be translated into a tree structure. The tree structure may be a DOM tree. At 1004, the selected portion may be mapped to a sub-tree of the tree structure by traversing the tree structure, ignoring layout-decorator nodes. At 1006, an anchor may be identified as a root of the sub-tree. At 1008, the anchor may be saved as a presentation rule. This may include saving the anchor as a tentative presentation rule and then prompting the user as to whether the presentation rule should be permanent, saving it as such if the user so indicates. The saving may also include saving the anchor as a presentation rule using XPath.

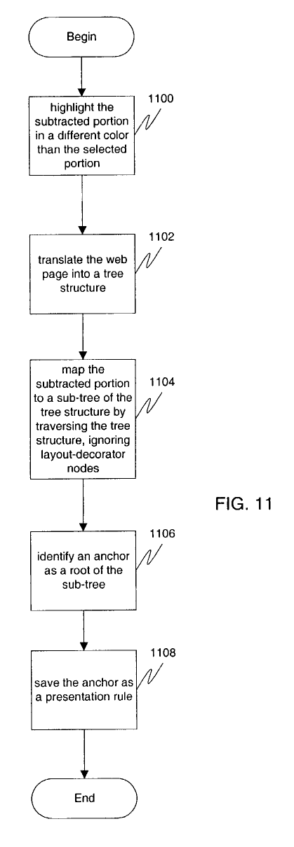

FIG. 11 is a flow diagram illustrating a method for subtracting a portion of a web page from a selected portion of the web page in accordance with a specific embodiment of the present invention. At 1100, the subtracted portion may be highlighted in a different color than the selected portion. This may include clicking and dragging. At 1102, the web page may be translated into a tree structure. The tree structure may be a DOM tree. At 1104, the subtracted portion may be mapped to a sub-tree of the tree structure by traversing the tree structure, ignoring layout-decorator nodes. At 1106, an anchor may be identified as a root of the sub-tree. At 1108, the anchor may be saved as a presentation rule. This may include saving the anchor as a tentative presentation rule and then prompting the user as to whether the presentation rule should be permanent, saving it as such if the user so indicates. The saving may also include saving the anchor as a presentation rule using XPath.

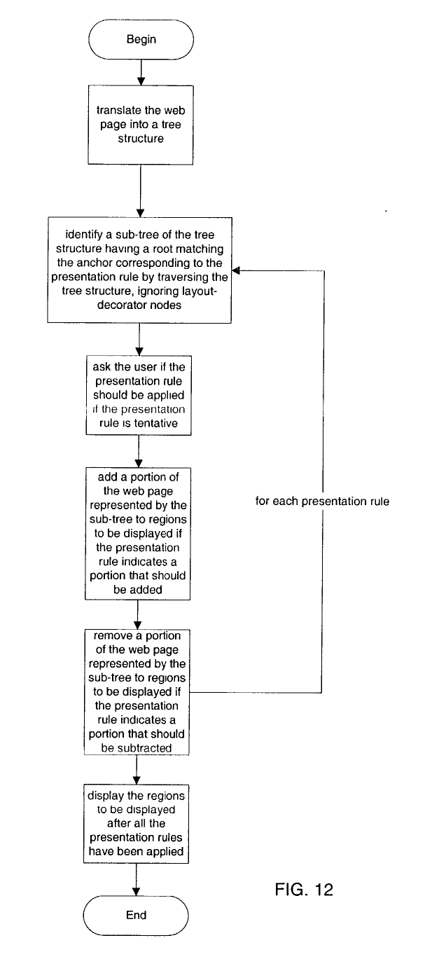

FIG. 12 is a flow diagram illustrating a method for displaying a web page in accordance with one or more presentation rules saved for the web page in accordance with a specific embodiment of the present invention. The one or more presentation rules may each be identified by an anchor indicating a root of a sub-tree to which the presentation rule applies. Each presentation rule may further indicate whether a portion identified by the anchor should be added or subtracted from the web page when displayed. The presentation rules may be specific to a user, and may be either tentative or permanent. At 1200, the web page may be translated into a tree structure. The tree structure may be a DOM tree. Then, for each presentation rule, at 1202 a sub-tree of the tree structure having a root matching the anchor corresponding to the presentation rule may be identified by traversing the tree structure, ignoring layout-decorator nodes. If the presentation rule is tentative, at 1204 the user may be asked if the presentation rule should be applied. If the presentation rule indicates a portion that should be added, at 1206 a portion of the web page represented by the sub-tree may be added to regions to be displayed. If the presentation rule indicates a portion that should be subtracted, at 1208 a portion of the web page represented by the sub-tree may be removed from the regions to be displayed. At 1210, after all the presentation rules have been applied, the regions to be displayed may be displayed.

It should be noted that in some cases, the web page may have changed so dramatically that the layout invariant property is ineffective in matching the saved presentation rule with a sub-tree. In such cases, the system may discard the presentation rule because it cannot be applied.

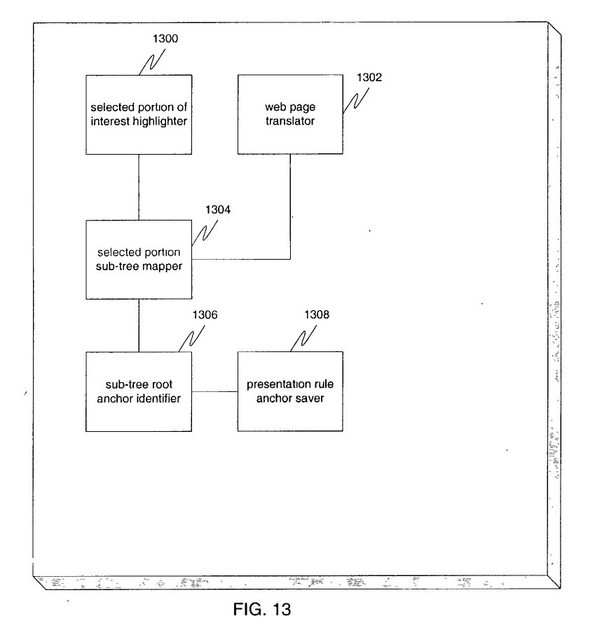

FIG. 13 is a block diagram illustrating an apparatus for selecting a portion of a web page in accordance with a specific embodiment of the present invention. A selected portion of interest highlighter 1300 may highlight a selected portion of interest of the web page. This may include clicking and dragging. A web page tree structure translator 1302 may translate the web page into a tree structure. The tree structure may be a DOM tree. A selected portion sub-tree mapper 1304 coupled to the selected portion of interest highlighter 1300 and the web page tree structure translator 1302 may map the selected portion to a sub-tree of the tree structure by traversing the tree structure, ignoring layout-decorator nodes. A sub-tree root anchor identifier 1306 coupled to the selected portion sub-tree mapper may identify an anchor as a root of the sub-tree. A presentation rule anchor saver 1308 coupled to the sub-tree root anchor identifier 1306 may save the anchor as a presentation rule. This may include saving the anchor as a tentative presentation rule and then prompting the user as to whether the presentation rule should be permanent, saving it as such if the user so indicates. The saving may also include saving the anchor as a presentation rule using XPath.

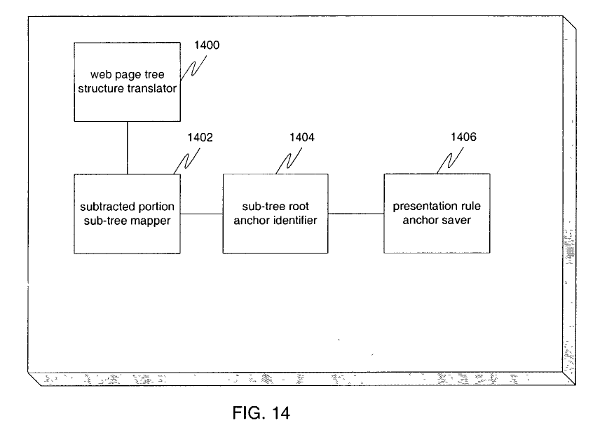

FIG. 14 is a block diagram illustrating an apparatus for subtracting a portion of a web page from a selected portion of the web page in accordance with a specific embodiment of the present invention. The subtracted portion may be highlighted in a different color than the selected portion. This may include clicking and dragging. A web page tree structure translator 1400 may translate the web page into a tree structure. The tree structure may be a DOM tree. A subtracted portion sub-tree mapper 1402 coupled to the web page tree structure translator 1400 may map the subtracted portion to a sub-tree of the tree structure by traversing the tree structure, ignoring layout-decorator nodes. A sub-tree root anchor identifier 1404 coupled to the subtracted portion sub-tree mapper 1402 may identify an anchor as a root of the sub-tree. A presentation rule anchor savor 1406 coupled to the sub-tree root anchor identifier 1404 may save anchor as a presentation rule. This may include saving the anchor as a tentative presentation rule and then prompting the user as to whether the presentation rule should be permanent, saving it as such if the user so indicates. The saving may also include saving the anchor as a presentation rule using XPath.

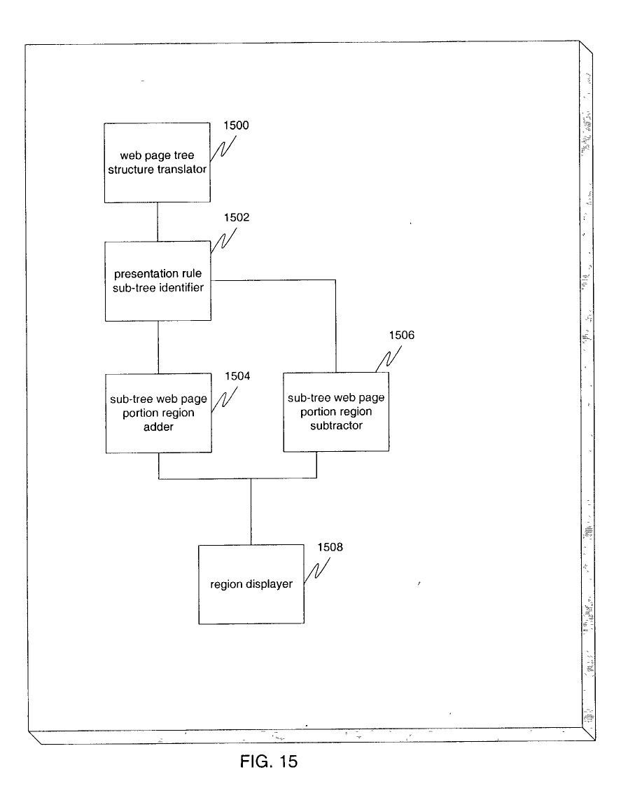

FIG. 15 is a block diagram illustrating an apparatus for displaying a web page in accordance with one or more presentation rules saved for the web page in accordance with a specific embodiment of the present invention. The one or more presentation rules may each be identified by an anchor indicating a root of a sub-tree to which the presentation rule applies. Each presentation rule may further indicate whether a portion identified by the anchor should be added or subtracted from the web page when displayed. The presentation rules may be specific to a user, and may be either tentative or permanent. A web page tree structure translator 1500 may translate the web page into a tree structure. The tree structure may be a DOM tree. Then, for each presentation rule, a presentation rule sub-tree identifier 1502 coupled to the web page tree structure translator 1500 may identify a sub-tree of the tree structure having a root matching the anchor corresponding to the presentation rule by traversing the tree structure, ignoring layout-decorator nodes. If the presentation rule is tentative, the user may be asked if the presentation rule should be applied. If the presentation rule indicates a portion that should be added, a sub-tree web page portion region adder 1504 coupled to the presentation rule sub-tree identifier 1502 may add a portion of the web page represented by the sub-tree to regions to be displayed. If the presentation rule indicates a portion that should be subtracted, a sub-tree web page portion region subtractor 1506 coupled to the added presentation rule sub-tree identifier 1504 may subtract a portion of the web page represented by the sub-tree to regions to be displayed. After all the presentation rules have been applied, a region displayer 1508 coupled to the sub-tree web page portion region adder 1504 and to the sub-tree web page portion region subtractor 1506 may display the regions to be displayed.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims. CLAIMS

What is claimed is:

1. A method for selecting a portion of a web page, the method comprising:
highlighting a selected portion of interest of the web page;
translating the web page into a tree structure;
mapping said selected portion to a sub-tree of said tree structure by traversing said tree structure, ignoring layout-decorator nodes;
identifying an anchor as a root of said sub-tree; and
saving said anchor as a presentation rule.

2. The method of claim 1, wherein said tree structure is a Document Object Model (DOM) tree.

3. The method of claim 1, wherein said highlighting comprises clicking and dragging.

4. The method of claim 1, wherein said saving comprises saving said anchor as a tentative presentation rule.

5. The method of claim 4, further comprising:
prompting said user as to whether said presentation rule should be permanent; and
saving said anchor as a permanent presentation rule.

6. The method of claim 1, wherein said saving comprises saving said anchor as a presentation rule using the Extensible Markup Language (XML) Path language (XPath).

7. A method for subtracting a portion of a web page from a selected portion of the web page, the method comprising:
translating the web page into a tree structure;
mapping said subtracted portion to a sub-tree of said tree structure by traversing said tree structure, ignoring layout-decorator nodes;
identifying an anchor as a root of said sub-tree; and
saving said anchor as a presentation rule.

8. The method of claim 7, further comprising:
highlighting said subtracted portion in a different color than the selected portion.

9. The method of claim 7, wherein said tree structure is a Document Object Model (DOM) tree.

10. The method of claim 7, wherein said highlighting comprises clicking and dragging.

11. The method of claim 7, wherein said saving comprises saving said anchor as a tentative presentation rule.

12. The method of claim 11, further comprising: prompting said user as to whether said presentation rule should be permanent; and
saving said anchor as a permanent presentation rule.

13. The method of claim 7, wherein said saving comprises saving said anchor as a presentation rule using the Extensible Markup Language (XML) Path language (XPath).

14. A method for displaying a web page in accordance with one or more presentation rules saved for the web page, the one or more presentation rules each identified by an anchor indicating a root of a sub-tree to which the presentation rule applies, each presentation rule further indicating whether a portion identified by the anchor should be added or subtracted from the web page when displayed, the method comprising:
translating the web page into a tree structure;
for each presentation rule:
identifying a sub-tree of said tree structure having a root matching the anchor corresponding to the presentation rule by traversing said tree structure, ignoring layout-decorator nodes; and
adding a portion of said web page represented by said sub-tree to regions to be displayed if the presentation rule indicates a portion to be added; and
displaying said regions to be displayed.

15. The method of claim 14, further comprising:
for each presentation rule
removing a portion of said web page represented by said sub-tree from said regions to be displayed if the presentation rule indicates a portion to be subtracted.

16. The method of claim 14, wherein the presentation rules are specific to a user.

17. The method of claim 14, wherein each of the presentation rules may be tentative or permanent.

18. The method of claim 17, further comprising:
asking a user if the presentation rule should be applied if the presentation rule is tentative.

19. The method of claim 14, wherein said tree structure is a Document Object Model (DOM) tree.

20. An apparatus for selecting a portion of a web page, the apparatus comprising:
a selected portion of interest highlighter;
a web page tree structure translator;
a selected portion sub-tree mapper coupled to said selected portion of interest highlighter and said web page tree structure translator;
a sub-tree root anchor identifier coupled to said selected portion sub-tree mapper; and
a presentation rule anchor saver coupled to said sub-tree root anchor identifier.

21. An apparatus for subtracting a portion of a web page from a selected portion of the web page, the apparatus comprising:
a web page tree structure translator;
a subtracted portion sub-tree mapper coupled to said web page tree structure translator;
a sub-tree root anchor identifier coupled to said subtracted portion sub-tree mapper; and
a presentation rule anchor savor coupled to said sub-tree root anchor identifier.

22. An apparatus for displaying a web page in accordance with one or more presentation rules saved for the web page, the one or more presentation rules each identified by an anchor indicating a root of a sub-tree to which the presentation rule applies, each presentation rule further indicating whether a portion identified by the anchor should be added or subtracted from the web page when displayed, the apparatus comprising:
a web page tree structure translator;
a presentation rule sub-tree identifier coupled to said web page tree structure translator;
a sub-tree web page portion region adder coupled to said presentation rule sub-tree identifier; and
a region displayer coupled to said sub-tree web page portion region adder.

23. The apparatus of claim 22, further comprising a sub-tree web page portion region subtractor coupled to said added presentation rule sub-tree identifier and to said region displayer.

24. An apparatus for selecting a portion of a web page, the apparatus comprising:
means for highlighting a selected portion of interest of the web page;
means for translating the web page into a tree structure;
means for mapping said selected portion to a sub-tree of said tree structure by traversing said tree structure, ignoring layout-decorator nodes;
means for identifying an anchor as a root of said sub-tree; and
means for saving said anchor as a presentation rule.

25. The apparatus of claim 24, wherein said tree structure is a Document Object Model (DOM) tree.

26. The apparatus of claim 24, wherein said means for highlighting comprises means for clicking and dragging.

27. The apparatus of claim 24, wherein said means for saving comprises means for saving said anchor as a tentative presentation rule.

28. The apparatus of claim 27, further comprising:
means for prompting said user as to whether said presentation rule should be permanent; and
means for saving said anchor as a permanent presentation rule.

29. The apparatus of claim 24, wherein said means for saving comprises means for saving said anchor as a presentation rule using the Extensible Markup Language (XML) Path language (XPath).

30. An apparatus for subtracting a portion of a web page from a selected portion of the web page, the apparatus comprising:
means for translating the web page into a tree structure;
means for mapping said subtracted portion to a sub-tree of said tree structure by traversing said tree structure, ignoring layout-decorator nodes;
means for identifying an anchor as a root of said sub-tree; and
means for saving said anchor as a presentation rule.

31. The apparatus of claim 30, further comprising:
means for highlighting said subtracted portion in a different color than the selected portion.

32. The apparatus of claim 30, wherein said tree structure is a Document Object Model (DOM) tree.

33. The apparatus of claim 30, wherein said means for highlighting comprises means for clicking and dragging.

34. The apparatus of claim 30, wherein said means for saving comprises means for saving said anchor as a tentative presentation rule.

35. The apparatus of claim 34, further comprising:
means for prompting said user as to whether said presentation rule should be permanent; and
means for saving said anchor as a permanent presentation rule.

36. The apparatus of claim 30, wherein said means for saving comprises means for saving said anchor as a presentation rule using the Extensible Markup Language (XML) Path language (XPath).

37. An apparatus for displaying a web page in accordance with one or more presentation rules saved for the web page, the one or more presentation rules each identified by an anchor indicating a root of a sub-tree to which the presentation rule applies, each presentation rule further indicating whether a portion identified by the anchor should be added or subtracted from the web page when displayed, the apparatus comprising:
means for translating the web page into a tree structure;
for each presentation rule:
means for identifying a sub-tree of said tree structure having a root matching the anchor corresponding to the presentation rule by traversing said tree structure, ignoring layout-decorator nodes; and
means for adding a portion of said web page represented by said sub-tree to a region to be displayed if the presentation rule indicates a portion to be added; and
means for displaying said region to be displayed.

38. The apparatus of claim 37, further comprising:
for each presentation rule
means for removing a portion of said web page represented by said sub-tree from said regions to be displayed if the presentation rule indicates a portion to be subtracted.

39. The apparatus of claim 37, wherein the presentation rules are specific to a user.

40. The apparatus of claim 37, wherein each of the presentation rules may be tentative or permanent.

41. The apparatus of claim 40, further comprising:
means for asking a user if the presentation rule should be applied if the presentation rule is tentative.

42. The apparatus of claim 37, wherein said tree structure is a Document Object Model (DOM) tree.

43. A program storage device readable by a machine, tangibly embodying a program of instructions executable by the machine to perform a method for selecting a portion of a web page, the method comprising:
highlighting a selected portion of interest of the web page;
translating the web page into a tree structure;
mapping said selected portion to a sub-tree of said tree structure by traversing said tree structure, ignoring layout-decorator nodes;
identifying an anchor as a root of said sub-tree;
saving said anchor as a presentation rule.

44. A program storage device readable by a machine, tangibly embodying a program of instructions executable by the machine to perform a method for subtracting a portion of a web page from a selected portion of the web page, the method comprising:
translating the web page into a tree structure;
mapping said subtracted portion to a sub-tree of said tree structure by traversing said tree structure, ignoring layout-decorator nodes;
identifying an anchor as a root of said sub-tree;
saving said anchor as a presentation rule.

45. A program storage device readable by a machine, tangibly embodying a program of instructions executable by the machine to perform a method for displaying a web page in accordance with one or more presentation rules saved for the web page, the one or more presentation rules each identified by an anchor indicating a root of a sub-tree to which the presentation rule applies, each presentation rule further indicating whether a portion identified by the anchor should be added or subtracted from the web page when displayed, the method comprising:
translating the web page into a tree structure;
for each presentation rule:
identifying a sub-tree of said tree structure having a root matching the anchor corresponding to the presentation rule by traversing said tree structure, ignoring layout-decorator nodes; and
adding a portion of said web page represented by said sub-tree to a region to be displayed if the presentation rule indicates a portion to be added; and displaying said region to be displayed.
